(19) United States
(12) Patent Application Publication
(10) Pub. No.: US 2018/0077523 A1
(43) Pub. Date: Mar. 15, 2018

(54) BEACON SYSTEM, DEVICE, AND METHOD

(71) Applicant: Siemens Industry, Inc., Alpharetta, GA (US)

(72) Inventor: Rene Herrera, Castle Pines, CO (US)

(73) Assignee: Siemens Industry, Inc., Alpharetta, GA (US)

(21) Appl. No.: 15/266,781

(22) Filed: Sep. 15, 2016

(51) Int. Cl. H04W 4/02; H04W 4/00; H04W 4/20; G01S 5/02

(52) U.S. Cl. CPC H04W 4/02; H04W 4/008; H04W 84/18; G01S 5/0226; G01S 5/0294; H04W 4/20

(57) ABSTRACT

Geographic beaconing system, methods, and mediums. A method includes transmitting a wireless beacon signal by the geographic beaconing system. The method includes receiving a response to the wireless beacon signal from a mobile device. The method includes determining a location of the mobile device based on the response. The method includes performing an action based on the location of the mobile device.

### TECHNICAL FIELD

The present disclosure is directed, in general, to wireless systems, and in particular to wireless beacon systems.

### BACKGROUND OF THE DISCLOSURE

Data collection, in general, is increasingly desirable in all aspects of the economy. Wireless “beacons” are among the most important new mobile technologies since they not only gather data for analytics but offer customers an enhanced digital experience. Beacon technology can be found in many important vertical industries, including retail, public, transportation, logistics, hospitality, events, and healthcare. This is similar to previous “geopush” technology based on GPS, but with a much reduced impact on battery life and much extended precision. Improved beacon systems are desirable.

### SUMMARY OF THE DISCLOSURE

Various disclosed embodiments relate to systems and methods for geographic beaconing.

A method includes transmitting a wireless beacon signal by the geographic beaconing system. The method includes receiving a response to the wireless beacon signal from a mobile device. The method includes determining a location of the mobile device based on the response. The method includes performing an action based on the location of the mobile device.

A geographic beaconing system includes a plurality of beacon nodes, a geographic gateway system connected to communicate with the beacon nodes, and at least one server system in communication with the geographic gateway system. The geographic beaconing system is configured to transmit a wireless beacon signal, receive a response to the wireless beacon signal from a mobile device, determine a location of the mobile device based on the response, and perform an action based on the location of the mobile device.

In various embodiments, the wireless beacon signal is transmitted by one of the beacon nodes that is implemented as a Bluetooth Low Energy beacon. In various embodiments, a first beacon node of the plurality of beacon nodes is installed in a streetlight. In various embodiments, the first beacon node receives power from the streetlight via a male connector to a photocontrol receptacle device. In various embodiments, the first beacon node also provides power to a photocontrol device via a female connector. In various embodiments, the response is received by the at least one server system from the mobile device over a network. In various embodiments, the response is received by a first beacon node of the plurality of beacon nodes and transmitted by the first beacon node to a server system.

The foregoing has outlined rather broadly the features and technical advantages of the present disclosure so that those skilled in the art may better understand the detailed description that follows. Additional features and advantages of the disclosure will be described hereinafter that form the subject of the claims. Those of ordinary skill in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a geographic beaconing system in which various embodiments are implemented;

FIG. 2 depicts a block diagram of a data processing system in which various embodiments are implemented;

FIGS. 3A-3C illustrate perspective views of one example of a beacon node in accordance with disclosed embodiments;

FIG. 4 illustrates depicts a flowchart of a process in accordance with disclosed embodiments;

FIG. 5 illustrates an example of a mobile device “app” user interface that can be used to make user selections that are then transmitted for use by the system;

FIG. 6 illustrates an example of a mobile device “app” user interface that is displaying a notification transmitted by the system as the action performed by the system based on the location of the mobile device and the user selections; and

FIG. 7 illustrates depicts a flowchart of another process in accordance with disclosed embodiments.

### DETAILED DESCRIPTION

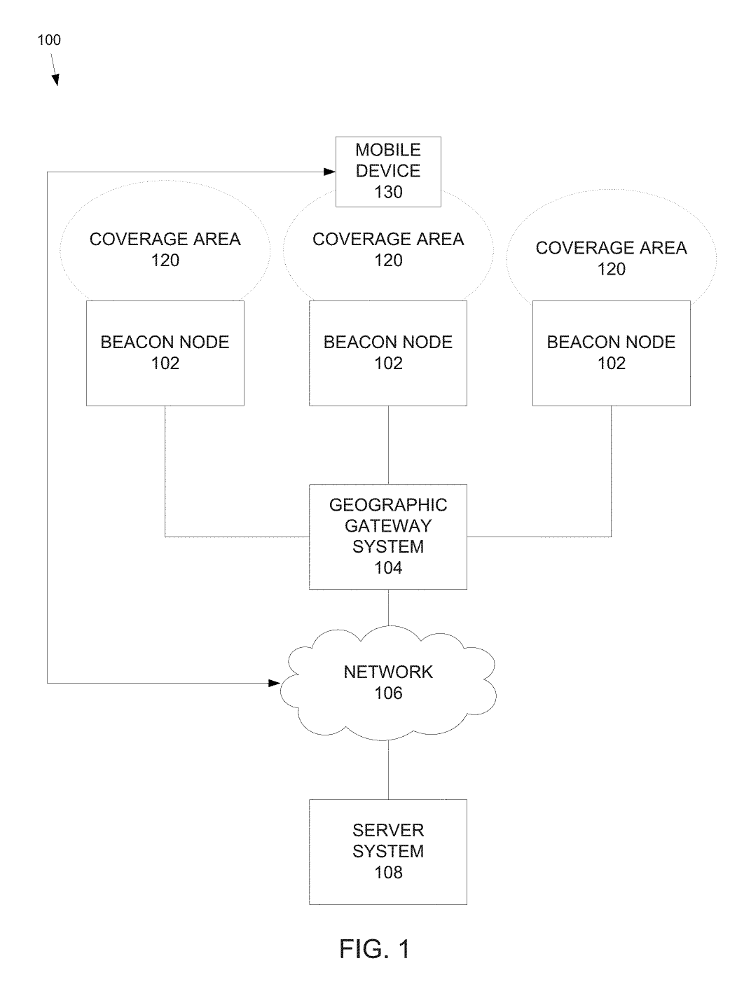

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device or system.

Embodiments of the present disclosure include systems and methods for providing wireless beaconing services over a geographic area, such as a neighborhood. In particular embodiments, a wireless beacon device is configured so that existing street-lighting infrastructure can be quickly and inexpensively retrofitted with wireless beaconing technology.

Wireless beacons are, in general, wireless nodes that periodically or occasionally broadcast a packet or signal that advertises their presence. The term “beacon” is used in several wireless technologies to describe such behavior. One such technology is the Bluetooth low energy (Bluetooth LE or BLE) wireless personal area network technology designed and marketed by the Bluetooth Special Interest Group aimed at novel applications in the healthcare, fitness, beacons, security, and home entertainment industries. Both the BLE and the Bluetooth Basic Rate/Enhanced Data Rate (BR/EDR) specifications describe beacon functions.

A BLE beacon is a wireless device that periodically broadcasts a Bluetooth Low Energy advertising packet that is received by a smartphone or other device and is then used by the device to determine its position with respect to the beacon itself. This allows for provisioning of “context-aware” information to the mobile user. For example, a Bluetooth beacon node sends a beacon signal to a limited area (the “coverage area”). In one-way communication implementations, this beacon signal can be detected by compatible devices that enter the coverage area, and used by those devices to determine their location and perform other functions based on the location. In two-way communication implementations, the devices can respond to the beacon signal, and that response is received by the beacon node. A server system in communication with the beacon node can then perform various functions based the device and where it was detected.

Disclosed embodiments include systems, methods, and devices for a “smart neighborhood” that leverages wireless beacon technology. While specific embodiments are described in terms of Bluetooth and BLE technology, the techniques described herein can be applied to other wireless communications technologies.

FIG. 1 illustrates a block diagram of a geographic beaconing system 100 in which various embodiments are implemented. In this illustrative embodiment, the geographic beaconing system includes a plurality of beacon nodes 102. Each of the beacon nodes 102 is a wireless beacon, and can in particular be a BLE beacon. The beacon nodes 102 can be mounted, for example, on street lights or other neighborhood infrastructure, including traffic signals, house lamps, traffic signs, or others. Each of the beacons 102 is connected to a power supply, for example the power supply of a street light or otherwise. Each beacon node 102 is connected to communicate with a geographic gateway system 104, by wireless, wireline, fiber optic, or other public or private network communication connections known to those of skill in the art. In particular embodiments, each beacon node 102 can participate in a wireless “mesh” with other beacon nodes, so that communication with the geographic gateway system 104 is performed indirectly through the wireless mesh network. In some cases, the wireless network can be a Bluetooth network. Each beacon node 102 has a respective coverage area 120 in which it can send and receive data. For example, in some cases, a coverage area 120 can correspond to a signal range or radius of 229 feet, but that effective range may vary depending on the specific conditions of each installation. Each beacon node has an assigned geographic location. Each beacon node 102 is configured to send or receive data from mobile devices 130 or other devices within the respective coverage area 120. Mobile devices 130 can include mobile telephones, laptops, tablet computers, automobile “infotainment” systems, or any other device that can interact with a beacon node 102 as described herein.

Geographic gateway system 104 sends and collects data from the beacon nodes 102. Geographic gateway system 104 can include software applications to perform functions as described herein.

Geographic gateway system 104 communicates over network 106 with one or more server systems 108. Each server system 108 can includes software applications to perform functions as described herein. Any given server system 108 may be commonly controlled or operated with the remainder of geographic beaconing system 100, or may be independently operated. The mobile devices, which may not be part of the geographic beaconing system 100 itself, can also communicate with network 106, and via network 106, with the one or more server systems 108.

In some implementations, where beacon nodes 102 are mounted on street lights or other neighborhood infrastructure (collectively, “infrastructure devices”), the infrastructure devices are also connected to communicate via a wired or wireless network, such as a street light wireless mesh network, and can similarly be connected to an infrastructure gateway system and, via the infrastructure gateway system, to an external public or private network, including the Internet. For example, the infrastructure devices can be connected to be monitored or controlled, via these network connections, by a remote infrastructure control server. Such communications, for example, can be performed using the BACnet data communication protocol.

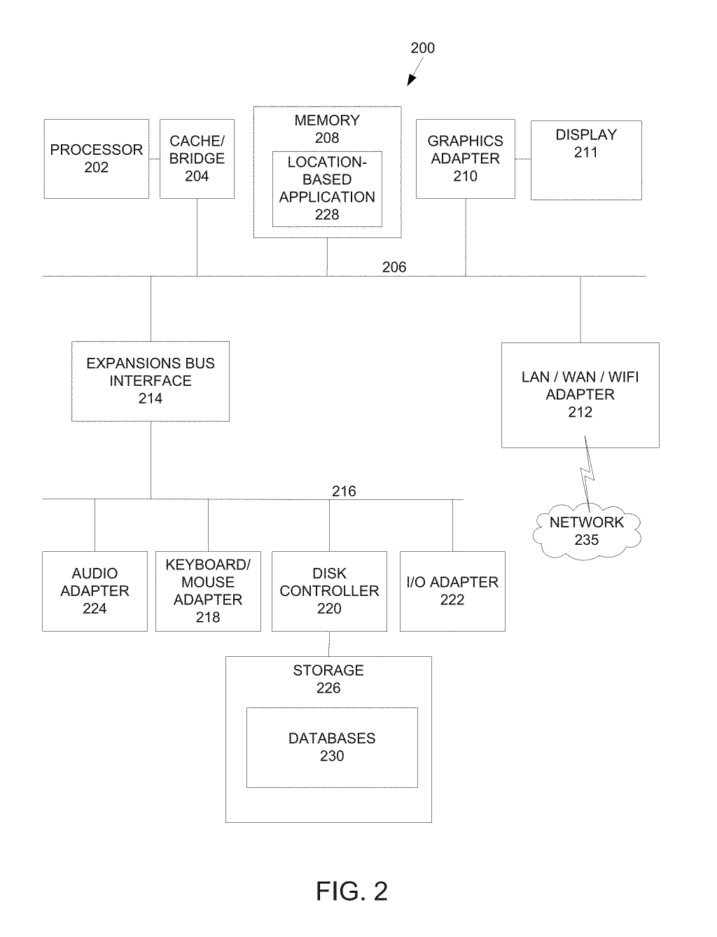

FIG. 2 depicts a block diagram of a data processing system 200 in which various embodiments are implemented. The data processing system 200 is an example of a system that can be used to implement a beacon node 102, a geographic gateway system 104, or a server system 108. The data processing system 200 includes a processor 202 connected to a level two cache/bridge 204, which is connected in turn to a local system bus 206. The local system bus 206 may be, for example, a peripheral component interconnect (PCI) architecture bus. Also connected to local system bus in the depicted example are a main memory 208 and a graphics adapter 210. The graphics adapter 210 may be connected to a display 211.

Other peripherals, such as a local area network (LAN)/Wide Area Network (WAN)/Wireless (e.g. WiFi or Bluetooth) adapter 212, may also be connected to local system bus 206. An expansion bus interface 214 connects the local system bus 206 to an input/output (I/O) bus 216. The I/O bus 216 is connected to a keyboard/mouse adapter 218, a disk controller 220, and an I/O adapter 222. The disk controller 220 may be connected to a storage 226, which may be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 226 (or memory 208) stores one or more databases 230 as described in more detail below.

Also connected to the I/O bus 216 in the example shown is an audio adapter 224, to which speakers (not shown) may be connected for playing sounds. The keyboard/mouse adapter 218 provides a connection for a pointing device (not shown), such as a mouse, trackball, trackpointer, etc. In some embodiments, the data processing system 200 may be implemented as a touch screen device, such as, for example, a tablet computer or touch screen panel. In these embodiments, elements of the keyboard/mouse adapter 218 may be implemented in connection with the display 211.

Those of ordinary skill in the art will appreciate that the hardware depicted in FIG. 2 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

One of various commercial operating systems, such as a version of Microsoft Windows™, a product of Microsoft Corporation located in Redmond, Wash. may be employed if suitably modified. The operating system may modified or created in accordance with the present disclosure as described, for example, to implement virtual demand auditing of one or more devices in a building.

LAN/WAN/Wireless adapter 212 may be connected to a network 235, such as for example, communicating between the systems, nodes, servers, or other devices described herein. As further explained below, the network 235 may be any public or private data processing system network or combination of networks, as known to those of skill in the art, including the Internet. Data processing system 200 may communicate over network 235 to one or more computers, which are also not part of data processing system 200, but may be implemented, for example, as a separate data processing system 200, and can implement any of the other systems discussed herein.

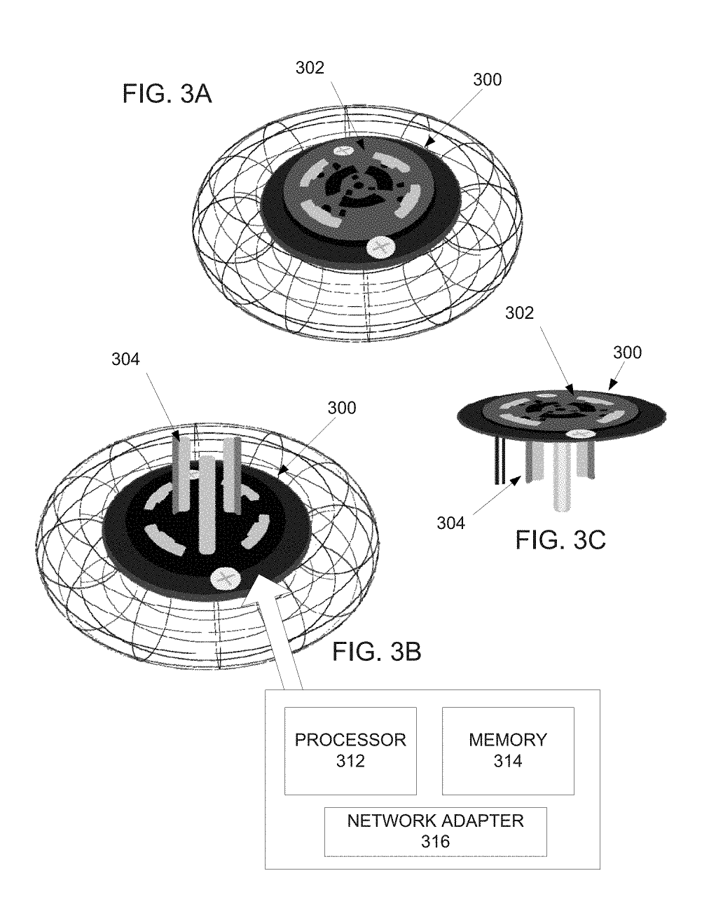

FIGS. 3A-3C illustrate perspective views of one example of a beacon node 300, in accordance with disclosed embodiments, that can be easily and inexpensively be installed on existing streetlamps, and can correspond to a beacon node 102.

In this example, beacon node 300, which can be implemented as a BLE beacon, has a round, substantially thin physical profile. Beacon node 300 includes at least a processor 312, memory 314, and network adapter 316 (which may include any necessary antennas), as described herein, to both provide wireless beacon functions, as described, and to communicate with the geographic gateway system, directly or indirectly, as described. In some embodiments, the beacon node 300 can also include one or more antennas that are external to a street light housing, and these can be a functional part of network adapter 316.

In specific embodiments, the beacon node 300 is physically configured to plug into a standard photo-control 5/7 position receptacle device, as is present on many typical streetlamps. Beacon node 300 can include both male and female connectors that conform to the “American National Standard for Roadway and Area Lighting Equipment-Dimming Control Between an External Locking Type Photocontrol and Ballast or Driver” (ANSI C136.41-2013), hereby incorporated by reference. FIG. 3A illustrates such a female connector 302, while FIG. 3B illustrates a male connector 304. FIG. 3C illustrates beacon 300 with both the female connector 302 and the male connector 304.

One specific example of a beacon node 300 is implemented in an IP65/IP66 rated plastic ring enclosure that houses 120-volt BLE beacon hardware. This enclosure has a photo-control male to female adapter embedded into the plastic ring. The beacon node 300 is powered by the male-to-female photo-control adapter.

Such an example implementation allows beacon node 300 to plug into a standard photo-control 5/7 position receptacle. This implementation provides a plastic and weatherproof installation for the beacon node 300 that typically does not require an external antenna. 2. The 120v BLE beacon will allow the use of the 120v power supply that is available on the standard photo-control 5/7 position receptacle of the street light pole.

As illustrated in FIG. 3B, the “pass through” 5/7 position receptacle adapter with both male and female connectors allows the install of any standard photo-control 5/7 position receptacle device to the streetlamp via the beacon node 300. That is, beacon node 300 is configured to plug into the female ANSI C136.41 dimming receptacle using its male connectors, which provides power to beacon node 300, and is also configured to allow a dimming or photocontrol device to be plugged into it using its female connectors, providing pass-through power to the plugged-in device.

According to disclosed embodiments, the beacon node 300 can include a IP65/IP66 rated plastic ring housing for BLE beacon hardware, a 120v input BLE beacon hardware board that includes processor 312, memory 314, and network adapter 316, and a 7-position photo-control receptacle adapter located between 5/7 position receptacle that provides the plastic housing for beacon node 300, and a female connector 302 for a photo-control device.

Other embodiments include power connections that may vary from the specific photo-control example describe above. In a more general case, the beacon node 300 can be configured to receive power from a streetlight via a streetlight power connector, and can be configured to provide power to a photocontrol device.

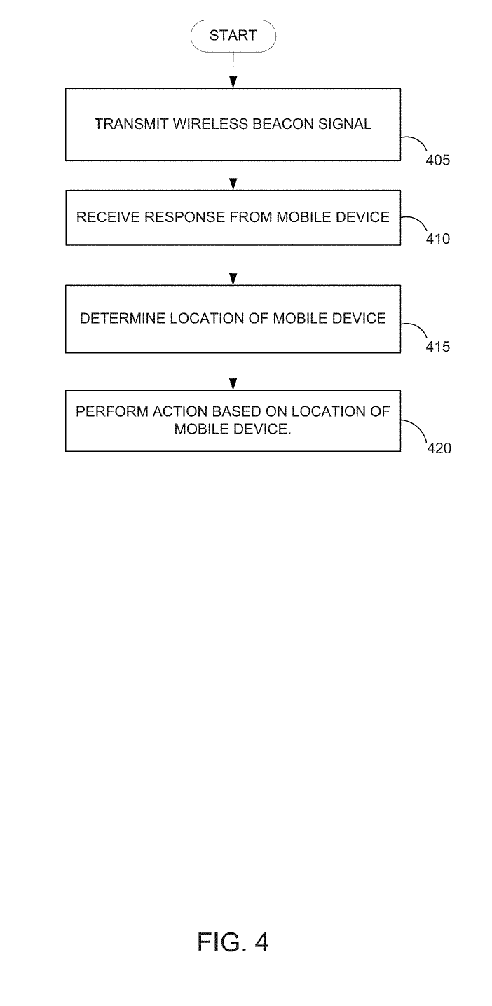

FIG. 4 depicts a flowchart of a process in accordance with disclosed embodiments. This process may be performed, for example, by a geographic beaconing system, such as geographic beaconing system 100, or a similar system with beacon nodes that interact with a mobile device as described herein, any of which, or any combination of which, are referred to in the singular as “the system.” The process may be implemented by executable instructions stored in a non-transitory computer-readable medium that cause one or more elements of the system to perform such a process. For example, the location-based application 228 may comprise the executable instructions to cause one or more data processing systems to perform such a process.

The system transmits a wireless beacon signal (405). This signal can be transmitted by a wireless beacon node such as a beacon node 102.

The system receives a response to the wireless beacon signal from a mobile device (410). This response can be received in different manners in different cases. For example, in a “one-way communication” beacon implementations, the response may be transmitted by the mobile device over a network (such as the Internet or network 106) to be received by the server system 108. In “two-way communication” beacon implementations, as another example, the response may be received by the beacon node itself from the mobile device, and thereafter transmitted by the beacon node to the server system 108.

The system determines a location of the mobile device based on the response (415). The wireless beacon signal can include an identifier of the specific beacon node and/or its geographic location (each of which can be considered “location information”), and the response can include the location information.

The system performs an action based on the location of the mobile device (420). A number of different examples are described below, and these generally include “smart neighborhood” functions that enhance the experience of mobile device users in the geographic area of the geographic beaconing system. In some embodiments, the action can also be based on one or more user selections corresponding to the mobile device.

Described below are several examples of potential alerts and other actions that can be performed according to disclosed embodiments. These examples are not intended to be limiting, but serve as examples of functions that performed by a system as disclosed herein.

For example, community residents that are interested in wildlife can be notified through a community app on their mobile device about wildlife activity closets to their location. In such an implementation, the mobile device user can make a user selection to be notified about wildlife activity, and the action performed by the system can be to send a notification to that mobile device about the wildlife activity. “App,” as used herein, can include any program or application running on any system, including mobile devices in particular.

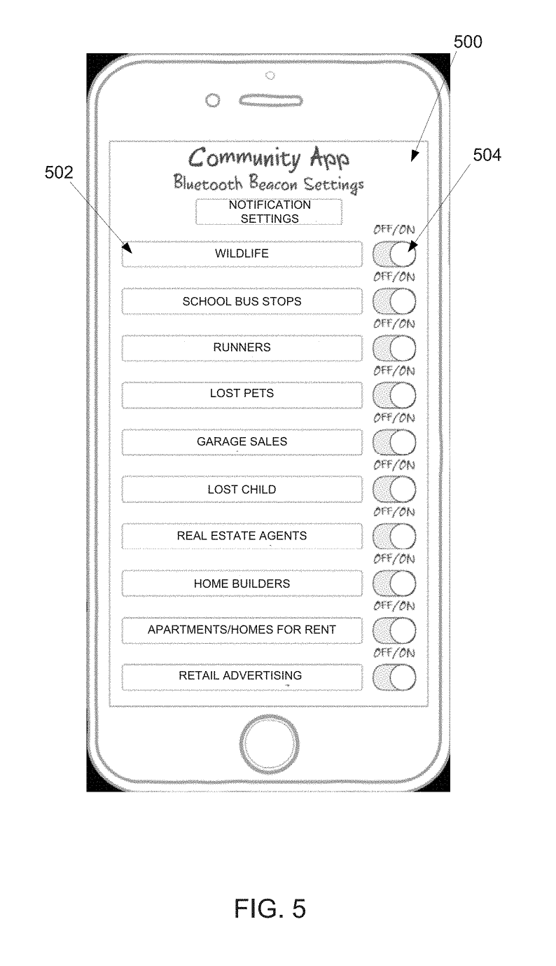

FIG. 5 illustrates an example of a mobile device “app” user interface 500 that can be used to make user selections that are then transmitted for use by the system. In this example, a number of possible notification types 502 are illustrated, and each of these has an associated selector 504 by which the user can select whether or not to be notified. In this example, the possible notification types are wildlife, school bus stops, runners, lost pets, garage sales, lost child, real estate agents, home builders, apartments/homes for rent, and retail advertising. Of course, possible notifications are not limited to these examples. Such user selections can be transmitted by the mobile device to the system, and associated by the system with the corresponding mobile device.

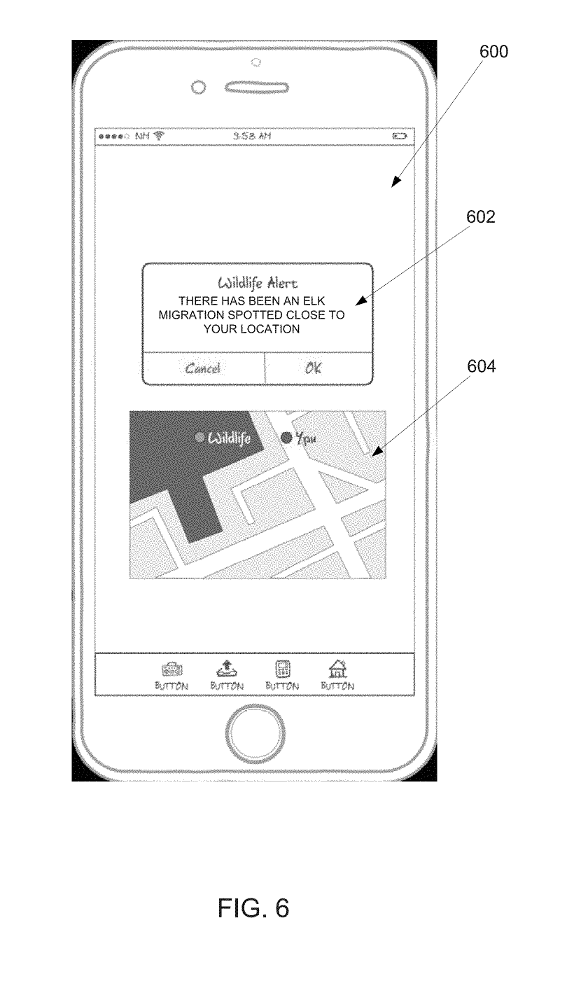

FIG. 6 illustrates an example of a mobile device “app” user interface 600 that is displaying a notification transmitted by the system as the action performed by the system based on the location of the mobile device and the user selections. In this example, for a “wildlife” notification, the system has performed the action of transmitting a notification to the mobile device. The mobile device displays the notification 602 and a map 604 of where the wildlife was sighted. Similar notifications can be used in the other examples discussed below.

As another example, the mobile device user can make a user selection to be notified about school bus stops, and the action performed by the system can be to send a notification to that mobile device about the status or location of a school bus with respect to a bus stop. In other cases, the system can monitor bus status and location based on mobile devices in the buses themselves, and trigger a street light RGB beacon to change color when the bus is approaching bus stop.

As another example, community runners that are interested in tracking their speed, distance, and time against other runners within the community could use the BLE beacons in the street lights and the community app to provide performance comparison stats, and the action taken by the system is to track the location and performance of the runners (via their mobile devices) and perform appropriate notifications.

As another example, pets within the community can be fitted with a BLE beacon or other mobile device in their collars so that, in the case of a lost pet, residents would be able to use the community app to track the direction in which the pet is heading relative to the street light poles, and the action taken by the system would be to track the pets and notify the owners.

As another example, while driving or walking through the community, residents could be notified about current or upcoming garage sales that are happening based on their location. The action taken by the system would include notifying the residents of nearby garage sales.

As another example, parents could choose to have their children wear a BLE beacon bracelet or other mobile device to provide the parents with peace of mind when their children are playing within the community. In this case, the action taken by the system would include tracking the location of the children and notifying the parents.

As another example, real estate agents could be notified whenever their potential buyers were visiting the community. In this case, the action taken by the system would include detecting the location of the buyers, via their mobile devices, and notifying the real estate agents.

As another example, home builders could be provided analytics to show how many potential buyers have visited their homes. They would also be able to see the duration of the visits. In this case, the action taken by the system would include tracking the location of the buyers (and the duration of their stay at any location) and notifying the home builders.

As another example, while looking for a home/apartment for rent potential tenants could drive through neighborhoods and be notified through the app and their cars infotainment system screen of homes for rent based on their location. In this case, the action taken by the system would include detecting the location of the potential tenants and notifying them of nearby available homes for sale or rent.

As another example, while driving through a neighborhood, the users can be notified of areas retails stores that provide coupons or suggestions for dinner. In this example, the action taken by the system would include detecting the location of the users via their mobile device and notifying them of nearby retail coupons or dining opportunities vie their mobile device, such as through the mobile app or their car's infotainment system screen. Similarly, while driving through areas where there are gas stations the drivers could be notified current gas prices through the mobile app and their cars infotainment system screen.

As another example, in a commercial setting, parking at an employer's parking lot or parking structure could trigger an event in a building automation system to set an employee's office to a pre-determined scene. For example, employee's computer could turn on, temperature set-point could change, light levels could adjust, window blinds could open, and door could unlock. In this example, the actions taken by the system can include detecting the employee's arrival at the employer location and transmitting instructions for the building automation system to set the “scene” or otherwise modify the workspace.

As another example, also in a commercial setting, leaving employer's parking lot or parking structure could trigger an event in the building automation system. For example, it would turn off employee's computer if it was left on, setback temperature set-point to save energy, turn off office lights to save energy, close window blinds to save energy, and lock a door if left unlocked. In this example, the actions taken by the system can include detecting the employee's departure from the employer location and transmitting instructions for the building automation system to “shut down” the corresponding office space or otherwise modify the workspace.

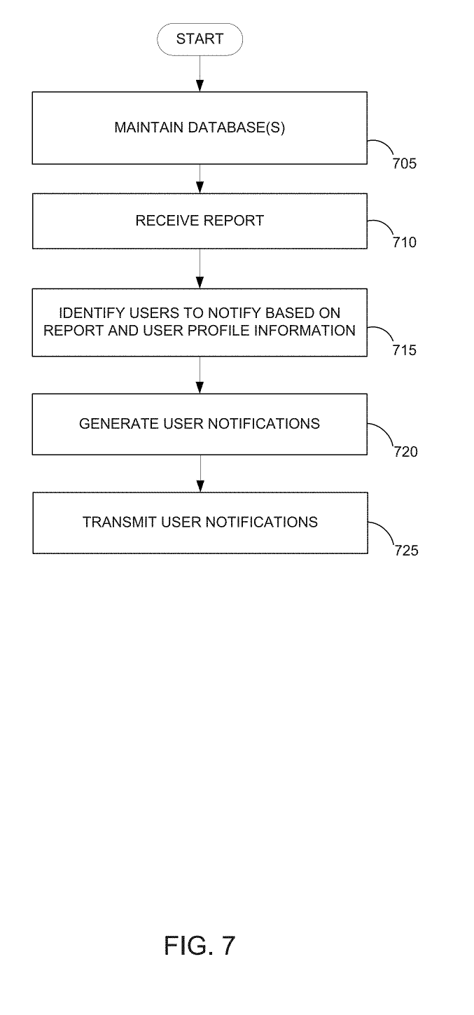

FIG. 7 illustrates a flowchart of a process in accordance with disclosed embodiments, showing an example implementation of a wildlife notification process as described herein that can be performed, for example, by geographic gateway system 103, server system 108, a combination of these, or another system configured to perform the processes described below, referred to generically as the “system” below. The system can be implemented, for example, by one or more data processing systems 200.

The system maintains one or more databases (705). The databases can include a beacon database that stores beacon identifiers, the location of each beacon associated with each beacon identifier, or other information about each beacon associated with each beacon identifier (for example, if the beacon is attached to a non-stationary object, person, or animal, an identification of that object, person, or animal). The databases can include a user account database that includes user profile information such as usernames, contact information, notification or other preferences, or other information; the notification preferences can include the types of notifications to receive, the locations for which the notifications should be received, and the user's preferences as to how the notifications are delivered, such as email, text message, mobile push notification, social networks, twitter, or home automation system touch screen. The databases can include a content database containing content to be delivered to users, such as addresses, notifications, text, images, audiovisual information, or other content. The databases can include a reaction database that stores instructions and configuration information for external systems such as HVAC systems, lighting control system, security systems, irrigation control systems, home automation systems, and other systems, so that those systems can be controlled or monitored as described herein. The databases can include a community database that includes community information such as information regarding school buses, wildlife, runners, pets, garage sales, and children. The databases can include a real estate database that includes such information as real estate agents, home builders, apartments or houses for rent, or other real estate information. The databases can include a retail database that includes information for retail stores, gas stations, and other such businesses. The databases can include an office building database that including information about office buildings, their automation or control systems, and other information. The databases can include a radio-frequency identification (RFID) tag database that includes information on RFID tags and the object, person, or animal with which each RFID tag is associated, and location information and identifiers of RFID readers. Location information, in any database, can include such information such as latitude and longitude coordinates, altitude, bearing, distance, accuracy data, place names, or time stamps. Of course, these exemplary databases are not limiting, and the particular names are not required. These databases can be implemented as the one or more databases 230.

For example, a user account database as described herein can store user account data in the user profile information that includes email address and other mobile device app settings. App settings can include app features that the end user would be interested in enabling, such as wildlife notifications or other notifications as described herein. App settings can include the ability to enable and disable notifications, and can include the preferred method by which the end user would like to be notified, including, for example, email, text message, mobile push notification, social network notifications, or by their home automation system. There will be a user account database that will store user profiles and preferences. Default settings could include having notifications for wildlife, lost pets, lost child, and retail advertising enabled. Location services can also be enabled as a default. The user profile information can specify if the users want to be notified when they are close, near or far from the wildlife (or other event for which there is a notification), or notify at all times when there is such an event. The user locations can be tracked by location services on their mobile devices.

The system receives a report (710), in this case a wildlife report. The report can be received in a variety of ways, in various embodiments. For example, the report can be received from a user's mobile device by a user who has sighted wildlife and is making an online report of the sighting. The report can be received by the system as an RFID tag reading, for example if tagged wildlife comes in the vicinity of an RFID tag reader, in which case the system can look up the RFID tag in the RFID tag database to identify the animal associated with the tag. The report can include location information, such as the location or identification of the RFID tag reader or the current location of the mobile device making the report, and can include a beacon identifier of a beacon detected by such a mobile device. When necessary, receiving the wildlife report can include identifying the location or type of the wildlife by looking up the RFID tag, RFID reader, or beacon identifier of the report in the respective database. This step can include storing the wildlife report. A similar process is used in other cases for other types of reports as described herein.

The specific wildlife example can use several techniques. For example, the wildlife can carry RFID tags, and the report is generated by RFID readers that read the serial numbers off the tags transmit that data to the system. The location can be determined, for example, by the signal strength between the RFID tag and the RFID reader. In another case, battery operated beacons can be attached to an animal tag or collar and can communicate via beacon gateways or Bluetooth readers that then communicate with the system. The location can be determined, for example, by the signal strength between the beacon and the beacon gateway. In other cases, the reports are received from users via a mobile device or App. The location can be determined, for example, by location services (such as latitude and longitude coordinates) of the mobile device.

The system identifies users to notify based on the report and the user profile information (715). This step can include searching the user profile information to identify users that have user setting to receive notifications corresponding to the received wildlife report (or other report, in other cases), including the type of report, the location of the sighted wildlife, the time or date of the sighting, or other information in the wildlife report. The identification can also be based on the current location of the user.

The system generates one or user notifications according to the identified users (720). This step can include generating the user notifications from data in the content database and according to the user profile information, such as the user's preferred notification types.

The system transmits the user notifications to the respective users (725). Again this can be performed in a number of different ways according to the user's preferred notification types as described in the user profile information. This step, in other cases, can include other actions taken by the system, such as sending instructions to control one or more of the systems identified in the reaction database, or others.

Note that various steps of the processes described above can be omitted or performed in a different order, performed sequentially, concurrently, or repeatedly, and that various aspects of the different processes can be combined. For example, the current location of a user in the process described with respect to FIG. 7, above, can be determined based on a process as described with respect to FIG. 4, above, where the identifying users for the notification, generating the notification, and transmitting the notification are actions taken based on the location of the user's mobile device.

Disclosed embodiments provide distinct technical advantages over present systems. In particular, disclosed embodiments enable a geographic beaconing system to automatically interact with and perform actions based on the presence of mobile devices in a geographic area. The disclosed beacon nodes can be easily installed across a geographic area, such as a neighborhood, and can leverage the existing infrastructure of the geographic area, such as street lights.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 200 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC § 112 unless the exact words “means for” are followed by a participle.

1. A method performed by a geographic beaconing system having a plurality of beacon nodes over a geographic area, comprising:
transmitting a wireless beacon signal by the geographic beaconing system;
receiving a response to the wireless beacon signal from a mobile device;
determining a location of the mobile device based on the response; and
performing an action based on the location of the mobile device,
wherein the wireless beacon signal is transmitted by a first beacon node of the plurality of beacon nodes that is installed in a streetlight, and
wherein the first beacon node comprises a connector to plug into a photocontrol receptacle of the streetlight.

2. The method of claim 1, wherein the wireless beacon signal is transmitted by a Bluetooth Low Energy beacon.

3. (canceled)

4. The method of claim 1, wherein the first beacon node receives power from the streetlight via a streetlight power connector.

5. The method of claim 4, wherein the first beacon node provides power to a photocontrol device.

6. The method of claim 1, wherein the response is received by a server system from the mobile device over a network.

7. The method of claim 1, wherein the response is received by the first beacon node of the plurality of beacon nodes and is transmitted by the first beacon node to a server system.

8. The method of claim 1, wherein the action includes sending a notification to the mobile device.

9. The method of claim 1, wherein the action includes sending instructions for a building management system to modify a workspace.

10. A geographic beaconing system, comprising:
a plurality of beacon nodes;
a geographic gateway system connected to communicate with the beacon nodes; and
at least one server system in communication with the geographic gateway system, wherein the geographic beaconing system is configured to:
transmit a wireless beacon signal;
receive a response to the wireless beacon signal from a mobile device;
determine a location of the mobile device based on the response; and
perform an action based on the location of the mobile device,
wherein a first beacon node of the plurality of beacon nodes is installed in a streetlight, and
wherein the first beacon node comprises a connector to plug into a photocontrol receptacle of the streetlight.

11. The geographic beaconing system of claim 10, wherein the wireless beacon signal is transmitted by one of the beacon nodes that is implemented as a Bluetooth Low Energy beacon.

12. (canceled)

13. The geographic beaconing system of claim 10, wherein the first beacon node receives power from the streetlight via a streetlight power connector.

14. The geographic beaconing system of claim 13, wherein the beacon node also provides power to a photocontrol device.

15. The geographic beaconing system of claim 10, wherein the response is received by the at least one server system from the mobile device over a network.

16. The geographic beaconing system of claim 10, wherein the response is received by a first beacon node of the plurality of beacon nodes and transmitted by the first beacon node to a server system.

17. The geographic beaconing system of claim 10, wherein the action includes sending a notification to the mobile device.

18. The geographic beaconing system of claim 10, wherein the action includes sending instructions for a building management system to modify a workspace.
